(19) United States
(12) Patent Application Publication
(10) Pub. No.: US 2018/0244874 A1
(43) Pub. Date: Aug. 30, 2018

(54) EPOXY RESIN COMPOSITIONS AND FIBER-REINFORCED COMPOSITE MATERIALS PREPARED THEREFROM

(71) Applicant: TORAY INDUSTRIES, INC., TOKYO (JP)

(72) Inventors: Benjamin Lehman, Tacoma, WA (US); Masahiro Hashimoto, Tacoma, WA (US); Jonathan Hughes, Tacma, WA (US); Takayuki Fujiwara, Tacoma, WA (US)

(73) Assignee: TORAY INDUSTRIES, INC., TOKYO (JP)

(21) Appl. No.: 15/754,493

(22) PCT Filed: Aug. 26, 2016
(86) PCT No.: PCT/IB2016/001248

§ 371 Date: Feb. 22, 2018

Related U.S. Application Data
(60) Provisional application No. 62/210,547, filed on Aug. 27, 2015.
(60) Provisional application No. 62/338,742, filed on May 19, 2016.

(51) Int. Cl. C08J 5/04; C08J 5/24; C08G 59/22; C08G 59/24; C08G 59/50; C08G 59/72

(52) U.S. Cl. CPC C08J 5/042; C08J 5/24; C08G 59/226; C08J 2363/00; C08G 59/50; C08G 59/72; C08G 59/24

(57) ABSTRACT

This invention relates to an epoxy resin composition for a fiber-reinforced composite material, which contains at least the following constituent components [A], [B], [C] and [D]:
[A] at least one epoxy resin (other than a cycloaliphatic epoxy resin represented by formula (I));
[B] at least one amine curing agent
[C] at least one latent add catalyst
[D] at least one cycloaliphatic epoxy resin represented by formula (I), wherein Y is a single bond or represents a divalent structure having a molecular weight less than 45 g/mol

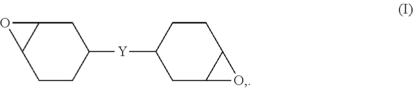

This epoxy resin composition is useful in the molding of fiber-reinforced composite materials. More particularly, it is possible to offer an epoxy resin composition for a fiber-reinforced composite material where the cured material obtained by heating has a high level heat resistance and strength properties.

### CROSS-REFERENCE TO RELATED APPLICATIONS

This application is the U.S. National Phase application of PCT/IB2016/001248, filed Aug. 26, 2016, which claims the benefit of priority of U.S. Provisional Application No. 62/210,547 filed on 27 Aug. 2015 and U.S. Provisional Application No. 62/338,742 filed on 19 May 2016, both entitled EPOXY RESIN COMPOSITIONS AND FIBER-REINFORCED COMPOSITE MATERIALS PREPARED THEREFROM, the contents of which are incorporated herein by reference in their entirety for all purposes.

### TECHNICAL FIELD OF THE INVENTION

The invention relates to epoxy resin compositions useful for producing fiber-reinforced composite materials.

### DISCUSSION OF THE RELATED ART

Fiber-reinforced composite materials comprising reinforcing fiber and a matrix resin are light weight and possess outstanding mechanical properties, so they are widely used in sports, aerospace and general industrial applications.

Thermosetting resins or thermoplastic resins are employed as the matrix resin for fiber-reinforced composite materials, but thermosetting resins are chiefly used due to their ease of processing. Amongst these, epoxy resins, which provide outstanding characteristics such as high heat resistance, high elastic modulus, low shrinkage on curing and high chemical resistance, are most often employed.

As epoxy resin curing agents, there are used polyamines, acid anhydrides, imidazole derivatives and the like. Here, a polyamine means a compound having a plurality of amine-type nitrogen atoms within the molecule and, furthermore, having a plurality of active hydrogens. Furthermore, ‘active hydrogen’ refers to a hydrogen atom which is bonded to an amine-type nitrogen atom. Polyamines have a long history of use and are curing agents of broad applicability. They are the widest used both in terms of type and amount and, currently, are indispensable in practical terms as curing agents for the epoxy resins used for fiber-reinforced composite materials.

In the case where an epoxy resin composition is employed in fiber-reinforced composite material applications, there will inevitably be included a stage in which reinforcing fiber is impregnated with the epoxy resin composition, so rheological control techniques for achieving a low resin viscosity at a stable temperature are extremely important.

Past resin compositions such as those disclosed in U.S. Pat. Pub. No. US20120231687A1 achieved a low resin viscosity at a stable temperature for impregnating reinforcing fibers using only glycidyl type epoxy resins. However the resin compositions disclosed in the aforementioned patent typically exhibit high viscosities at room temperature making prepreg obtained from impregnating these compositions into reinforcing fibers difficult to handle at ambient temperatures.

Including a cycloaliphatic epoxy resin in a resin composition can reduce the viscosity relative to an epoxy resin composition containing only glycidyl type epoxy resins, as disclosed in U.S. Pat. Pub. No. 20030064228. However, in the case of U.S. Pat. Pub. No. 20030064228, the cycloaliphatic epoxies used to reduce the viscosity also reduce the glass transition temperature of the cured matrix because of their large aliphatic backbone. To solve this problem, the present invention involves incorporating a cycloaliphatic epoxy wherein the cycloaliphatic epoxy moieties are connected by a linkage group having a molecular weight less than 45 g/mol to achieve both a high level of heat resistance in the cured matrix and low viscosity at room temperature.

In order for an epoxy resin composition to have advantageous characteristics from the viewpoint of the manufacturability of fiber-reinforced prepregs, the composition should have a viscosity increase of less than two times the starting viscosity when held at suitable temperatures for two hours. Achieving a viscosity increase of less than two is easily achieved using glycidyl type epoxy resins and curing with aromatic amines. However, epoxy resin compositions containing cycloaliphatic epoxy resin and cationic catalysts such as U.S. Pat. Pub. No. 20030064228 cannot meet this requirement due to the high reactivity of the cycloaliphatic epoxy with a strong Lewis acid catalyst. To solve this problem, the present invention employs a latent acid salt and amine curing agent at particular ratios to control the viscosity increase rate to be less than two times the starting viscosity when held at suitable temperatures for two hours.

One embodiment of the present invention lies in offering an epoxy resin composition for fiber-reinforced composite materials which is suitable for use in impregnating reinforcing fibers, more particularly, offering an epoxy resin composition for fiber-reinforced composite materials where the cured material obtained by heating has a high level of heat resistance and which is suitable for use as aircraft components and the like.

With respect to the mechanical properties of carbon fiber-reinforced composite materials, different design allowables are used when designing with composite materials depending on the status of stress, the geometry and the boundary conditions that characterize the composite material considered. One such design allowable is notched properties. Notched properties are very important when the designed structure contains holes and when fasteners are used. Notched properties measure the ability of a given composite material to carry load once a hole is drilled on the load bearing region of the composite material itself. Two notable notched properties are Open Hole Tensile Strength (OHT) and Open Hole Compressive Strength (OHC). These notched properties are typically the critical design allowables for parts intended for use in primary structures.

Further, because mechanical properties, particularly the compressive strength, are greatly decreased under hot-wet conditions (H/W), open hole compressive strength under hot-wet conditions becomes very important. Although conventional epoxy-based composite materials can exhibit acceptable OHC strength under hot-wet conditions at temperatures less than 120° C., their performance at higher temperatures is still not sufficient. At temperatures as high as 180° C. under hot-wet conditions, OHC properties are desired to be further improved for enlarging the range of the applicable uses of epoxy-based carbon fiber-reinforced composite materials.

### SUMMARY OF THE INVENTION

This invention relates to an epoxy resin composition for a fiber-reinforced composite material, which comprises, consists essentially of, or consists of the following constituent components [A], [B], [C] and [D]:
[A] at least one epoxy resin which is not a cycloaliphatic epoxy resin of formula (I);
[B] at least one amine curing agent;
[C] at least one latent acid catalyst; and
[D] at least one cycloaliphatic epoxy resin represented by formula (I), wherein Y is a single bond or represents a divalent moiety having a molecular weight less than 45 g/mol

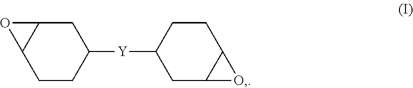

This epoxy resin composition is useful in the molding of fiber-reinforced composite materials. More particularly, the present invention makes it possible to provide an epoxy resin composition for a fiber-reinforced composite material where the cured material obtained by heating has a high level heat resistance and strength properties. In the field of this invention, a material having a high level of heat resistance is defined as a material having a high glass transition temperature and mechanical properties at or close to that temperature.

In one embodiment, component [C] of the epoxy resin composition includes at least one onium salt catalyst. In another embodiment, component [C] includes an onium salt catalyst represented by formula (II):

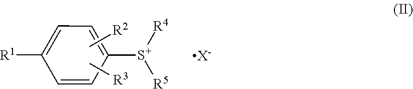

wherein R¹ represents a hydrogen atom, a hydroxyl group, an alkoxyl group, or a group represented by formula (III):

Y′—C(═O)—O— (III)

wherein Y′ represents an alkyl group, an alkoxyl group, a phenyl group or a phenoxy group, all of which may have one or more substituents, each of R² and R³ independently represents a hydrogen atom, a halogen atom, or an alkyl group, each of R⁴ and R⁵ independently represents an alkyl group, an aralkyl group or an aryl group, each of which may have one or more substituents, and X⁻ represents SbF₆⁻, PF₆⁻, AsF₆⁻, or BF₄⁻.

In one embodiment of the invention, component [A] of the epoxy resin composition includes at least one aromatic epoxy resin with two or more epoxy functionalities (i.e., two or more epoxy groups per molecule). In another embodiment, [A] includes at least one epoxy resin containing one or more naphthalene moieties. The amount of such naphthalene moiety-containing epoxy resin may, in one embodiment, be 20 to 80 percent by weight of the total amount of epoxy resin in the epoxy resin composition. In another embodiment, component [A] may include at least one epoxy resin selected from the group consisting of triglycidyl ethers of tris(p-hydroxyphenyl)methane, N,N,N′,N′-tetraglycidyl-4,4′-diaminodiphenylmethane, triglycidyl-m-aminophenol, diglycidyl ethers of 1,6-dihydroxynaphthalene, and tetraglycidyl ethers of 1,6-bis(2-naphthyl)methane.

According to one aspect of the invention, the epoxy resin composition may exhibit a viscosity increase of less than 200% after two hours at 65° C.

In a further aspect of the invention, the epoxy resin composition may be characterized by exhibiting a difference in temperature between T₁ and T₂ of between 40 and 170° C., T₁ being the temperature corresponding to the primary reaction peak in the DSC curve measured for the mixture of [A] and [B], and T₂ being the temperature corresponding to the primary reaction peak in the DSC curve measured for the mixture of [C] and [D]. For example, the difference in temperature between T₁ and T₂ may be between 70 and 120° C. The epoxy resin composition may have a substantially singular reaction peak (e.g., a single reaction peak) in the DSC curve under a ramp rate of 10° C./min.

In further embodiments of the invention, the epoxy resin composition may additionally comprise at least one thermoplastic resin, such as a polyethersulfone.

According to one aspect of the invention, component [B] of the epoxy resin composition may include at least one aromatic polyamine, such as a diaminodiphenylsulfone.

With respect to component [D], in various embodiments of the invention Y may be a single bond (i.e., the cycloaliphatic epoxy resin is bis(3,4-epoxycyclohexyl)), O, C(CH₃)₂, CH₂, or an oxirane ring.

In a further embodiment of the invention:
[A] includes at least one epoxy resin selected from the group consisting of triglycidyl ethers of tris(p-hydroxyphenyl)methane, N,N,N′,N′-tetraglycidyl-4,4′-diaminodiphenylmethane, triglycidyl-m-aminophenol, diglycidyl ethers of 1,6-dihydroxynaphthalene, and tetraglycidyl ethers of 1,6-bis(2-naphthyl)methane;
[B] includes at least one aromatic polyamine;
[C] includes at least one onium salt catalyst;
[D] includes at least one cycloaliphatic epoxy resin having a linkage group which is a single bond, O, C(CH₃)₂, CH₂ or an oxirane ring;
and the epoxy resin composition additionally comprises at least one thermoplastic resin.
   According to yet another embodiment of the invention:
[A] includes at least one epoxy resin containing one or more naphthalene moieties;
[B] includes at least one diaminodiphenylsulfone;
[C] includes at least one onium salt catalyst represented by formula (II):

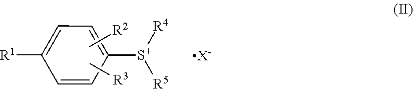

wherein R¹ represents a hydrogen atom, a hydroxyl group, an alkoxyl group, or a group represented by formula (III):

Y′—C(═O)—O— (III)
wherein Y′ represents an alkyl group, an alkoxyl group, a phenyl group or a phenoxy group, all of which may have one or more substituents, each of R² and R³ independently represents a hydrogen atom, a halogen atom, or an alkyl group, each of R⁴ and R⁵ independently represents an alkyl group, an aralkyl group or an aryl group, each of which may have one or more substituents, and X⁻ represents SbF₆⁻, PF₆⁻, AsF₆⁻, or BF₄⁻;
[D] includes at least one cycloaliphatic epoxy resin having a linkage group which is a single bond, O, C(CH₃)₂, CH₂ or an oxirane ring;
and the epoxy resin composition additionally comprises at least one polyethersulfone.

Also provided by the present invention are prepregs comprising carbon fibers impregnated with an epoxy resin composition in accordance with any of the above-mentioned embodiments as well as a carbon fiber-reinforced composite material obtained by curing such a prepreg. Further embodiments of the invention provide a carbon fiber-reinforced composite material comprising a cured resin product obtained by curing a mixture comprised of an epoxy resin composition in accordance with any of the above-mentioned embodiments and carbon fibers.

### BRIEF DESCRIPTION OF THE DRAWING

FIG. 1 shows the DSC curves of the epoxy resin compositions used in Example 8 and Example 9.

### DETAILED DESCRIPTION OF THE INVENTION

As a result of extensive research in view of the difficulties described above, the inventors have discovered that the aforementioned problems are resolved by employing, in fiber-reinforced composite material applications, an epoxy resin composition formed by mixing at least one epoxy resin, at least one amine curing agent, at least one latent acid catalyst and at least one cycloaliphatic epoxy resin having certain structural features, wherein the at least one epoxy resin is an epoxy resin other than a cycloaliphatic epoxy resin having such structural features.

In the present invention, an epoxy resin means an epoxy compound having at least two 1,2-epoxy groups within the molecule, that is to say one which is at least difunctional.

In the present invention, constituent component [A] preferably includes (or consists essentially of or consists of) at least one aromatic glycidyl ether type epoxy resin and/or at least one aromatic glycidyl amine type epoxy resin. Including these types of epoxies in the resin composition improves both the elastic modulus and the heat resistance of the cured material.

In spite of their benefits, aromatic glycidyl ether type and aromatic glycidyl amine type epoxies have fairly high viscosities making them difficult to process. To solve this problem, they may be combined with another low molecular weight epoxy, such as a cycloaliphatic epoxy component [D], as disclosed in U.S. Pat. Pub. No. 20030064228.

Among the epoxy resins usable as constituent component [A], difunctional epoxy resins such as glycidyl ether type epoxy resins with phenol as the precursor thereof can be preferably used. Examples of such an epoxy resin include the diglycidyl ethers of bisphenol A, E, or S; naphthalene type epoxy resins; biphenyl type epoxy resins; urethane-modified epoxy resins; hydantoin type epoxy resins; resorcinol type epoxy resins; and the like and combinations thereof.

It may be preferred to use a liquid bisphenol A type epoxy resin, a bisphenol E type epoxy resin, or a resorcinol type epoxy resin in combination with another epoxy resin, since such liquid resins have low viscosities.

Further, a solid bisphenol A type epoxy provides a structure, when cured, with a lower crosslinking density compared with the structure obtained by curing a liquid bisphenol A type epoxy resin and consequently lowers the heat resistance. However, when used in combination with a glycidyl amine type epoxy resin, a liquid bisphenol A type epoxy resin or a bisphenol E type epoxy resin, a structure with higher toughness can be obtained.

Further examples of tri- or higher-functional glycidyl ether type epoxy resin include phenol novolac type epoxy resins, ortho-cresol novolac type epoxy resins, tris-hydroxyphenyl methane type epoxy resins, bisnaphthalene type epoxy resins, tetraphenylolethane type epoxy resins, and combinations thereof.

Among the epoxy resins usable as constituent component [A], tri- or higher-functional glycidyl amine type epoxy resins including diaminodiphenyl methane type epoxy resins, diaminodiphenylsulfone type epoxy resins, aminophenol type epoxy resins, metaxylenediamine (MXDA) type epoxy resins, 1,3-bisaminomethylcyclohexane type epoxy resins, isocyanurate type epoxy resins, and the like and combinations thereof may be used. Among them, in view of a good balance of physical properties, diaminodiphenylmethane type epoxy resins and aminophenol type epoxy resins in particular can be used.

If the amount of tri- or higher-functional epoxy resins [A] is too small, heat resistance is impaired. If the amount is too large, the crosslinking density becomes high and the material may be brittle. Hence, the impact resistance and strength of the carbon fiber-reinforced composite material may be impaired.

An epoxy resin having a naphthalene skeleton (i.e., an epoxy resin containing one or more naphthalene moieties) gives a cured resin with low water absorption and high heat resistance. These attributes make naphthalene type epoxy resins ideal components for epoxy resin compositions requiring excellent performance under hot/wet conditions. Naphthalene type epoxy resins are epoxy resins containing two or more epoxy groups and one or more naphthalene moieties, such as, for example, the diglycidyl ether of 1,6-hydroxynaphthalene and the tetraglycidylether of 1,6-bis(2-naphthyl)methane.

If the amount of naphthalene type epoxy resin is too small, water absorption and heat resistance are impaired. If the amount is too large, the crosslinking density becomes low and the material may lack rigidity. Hence, the rigidity of the carbon fiber-reinforced composite material may be impaired. It is preferred that the amount of naphthalene type epoxy resin is 20 to 80 percent by weight of the total amount of epoxy resins. A more preferred range is 50 to 70 percent by weight.

Specific examples of suitable aromatic glycidyl ether type epoxy resins are the triglycidyl ethers of tris(p-hydroxyphenyl)methane, the diglycidyl ethers of 1,6-dihydroxynaphthalene, the tetraglycidyl ethers of 1,6-bis(2-naphthyl)methane and the like.

Specific examples of suitable aromatic glycidyl amine type epoxy resins include N,N,N′,N′-tetraglycidyl-4,4′-diaminodiphenylmethane, N,N,N′,N′-tetraglycidyl-4,4′-methylenebis(2-ethylbenzenamine), triglycidyl-m-aminophenol and the like. In the present invention, epoxy resins which combine both aromatic glycidyl ether type epoxy resin and aromatic glycidyl amine type epoxy resin structures are included amongst the aromatic glycidyl amine type resins.

In this invention, a thermosetting resin which is not an epoxy resin can also be present in the epoxy resin composition in addition to the epoxy resin(s). Examples of such thermosetting resins which may be used together with epoxy resin(s) in the epoxy resin composition of the present invention include unsaturated polyester resins, vinyl ester resins, benzoxazine resins, phenol resins, urea resins, melamine resins, polyimide resins, and the like. Any one of these thermosetting resins can be used alone or two or more of them can also be used in combination as appropriate. When such a further thermosetting resin is included, it should be intended to assure resin flowability and toughness after curing.

In the present invention, constituent component [B] is an amine curing agent. The curing agent referred to here is a compound having an active group capable of reacting with an epoxy group and/or accelerating the self-polymerization of epoxy groups. Examples of suitable curing agents include, but are not limited to, dicyandiamide, aromatic polyamines, aminobenzoic acid esters, polyphenol compounds, imidazole derivatives, aliphatic amines, tetramethylguanidine, thiourea-added amines, and carboxylic acid amides. Combinations and mixtures of different amine curing agents may be utilized.

If an aromatic polyamine is used as the curing agent, a cured epoxy resin product with good heat resistance can be obtained. Specifically, diaminodiphenylsulfone-based curing agents are often employed because curing epoxy resins with this type of amine curing agent results in cured products having high heat resistance. As a result, diaminodiphenylsulfone-based curing agents are favorably employed as the chief component of a curing agent for prepreg use. These curing agents may be supplied as a powder and are preferably employed in the form of a mixture with a liquid epoxy resin composition.

Non-limiting examples of constituent component [B] are m- or p-phenylenediamine, 2,4- or 2,6-diaminotoluene, 2,4- or 2,6-diamino-1-methyl-3,5-diethylbenzene, 3-isopropyl-2,6-diaminotoluene, 5-isopropyl-2,4-diaminotoluene, 5-t-butyl-2,4-diaminotoluene, 3-t-butyl-2,6-diaminotoluene, 3,5-diethylthio-2,4-diaminotoluene, 1,3,5-triethyl-2,6-diamino-benzene, 4,4′-diaminodiphenylmethane, 3, 3′,5,5′-tetraethyl-4,4′-diaminodiphenylmethane, 3,3′,5,5′-tetra-propyl-4,4′-diaminodiphenylmethane, 3,3′-diethyl-4,4′-diaminodiphenylether, 3,4′-diaminodiphenylether, 5,7-diamino-1,1-dimethylindane, 4,6-diamino-1,1-dimethylindane, 4,7-diamino-1,1-dimethylindane, 5,7-diamino-1,1,4,6-tetra-methylindane, 4,4′-diaminodiphenylsulfone, 3,3′-diaminodiphenylsulfone, and combinations thereof.

The amount of amine curing agent [B] present in the epoxy resin compositions of the present invention may be varied and selected as may be desired or needed in order to obtain the desired curing characteristics and final cured properties and will depend upon, for example, the type of amine curing agent(s) used, the types of epoxy resin(s) used, curing conditions and so forth. Typically, however, component [B] represents from about 5 parts by weight to about 60 parts by weight per 100 parts by weight of epoxy resin ([A]+[D]) in the epoxy resin composition.

In the present invention, constituent component [C] is a latent acid catalyst. This latent acid catalyst is a compound which essentially does not function as a catalyst at temperatures in the vicinity of room temperature, but in the high temperature region in which the curing of the epoxy resin is carried out, normally 70-200° C., it either itself functions as an acid catalyst or produces chemical species which serve as an acid catalyst. In the case of the production of chemical species which serve as an acid catalyst, this may be brought about, for example, due to thermal reaction alone or by reaction with epoxy resin or polyamine present in the system.

In the present invention, the latent acid catalyst is preferably employed in a state completely dissolved in the resin composition. Consequently, constituent component [C] may be soluble in constituent component [A], constituent component [D] or a mixture of constituent components [A] and [D].

Here, soluble in constituent component [A] or in constituent component [D] means that when the latent acid catalyst and the constituent component [A] or constituent component [D] are mixed together at a specified compositional ratio and stirred, a uniform mixed liquid can be formed. Here, the uniform mixed liquid is formed with up to 5 parts by weight of the latent acid catalyst substantially dissolving per 100 parts by weight of constituent component [A] and constituent component [D] at 65° C.

Examples of constituent component [C] are onium salts of strong acids, such as quaternary ammonium salts, quaternary phosphonium salts, quaternary arsonium salts, tertiary sulphonium salts, tertiary selenonium salts, secondary iodonium salts, and diazonium salts of strong acids and the like. Strong acids may be generated either by the heating of these on their own or, for example, as disclosed in JP-A-54-50596, by the reaction of a diaryliodonlum salt or triarylsulfonium salt and a reducing agent such as thiophenol, ascorbic acid or ferrocene, or alternatively, as disclosed in JP-A-56-76402, by the reaction of a diaryliodonium salt or triarylsulfonium salt and a copper chelate. The species of strong acid generated will be determined by the onium salt counter ion. As the counter ion, there is preferably employed one which is substantially not nucleophilic and where its conjugate acid is a strong acid. Examples of the preferred counter ion here are perchlorate ion, tetrafluoroborate ion, sulfonate ion (p-toluenesulfonate ion, methanesulfonate ion, trifluoromethanesulfonate ion and the like), hexafluorophosphate ion, hexafluoroantimonate ion, tetrakis(pentafluorophenyl)borate ion and the like. Onium salts having these counter ions, while being ionic salts, are outstanding in their solubility in organic compounds and are suitable for use in the present invention.

When combined with cycloaliphatic epoxy resins, sulfonium salt complexes with hexafluoroantimonate and hexafluorophosphate counter ions have superior latency to strong Lewis acids including BF₃/piperidine complexes, as disclosed in U.S. Pat. Pub. No. 20030064228, due to their higher dissociation temperature. Superior latency is an advantageous characteristic from the viewpoint of the manufacturability of fiber-reinforced prepregs.

In this invention, the epoxy resin composition preferably contains the sulfonium salt represented by formula (II);

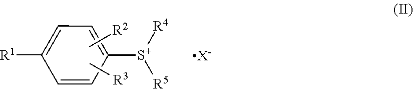

wherein R¹ represents a hydrogen atom, a hydroxyl group, an alkoxyl group, or a group represented by formula (III):

Y′—C(═O)—O— (III)

wherein Y′ represents an alkyl group, an alkoxyl group, a phenyl group or a phenoxy group, each of which may have a substituent. Each of R² and R³ independently represents a hydrogen atom, a halogen atom, or an alkyl group. Each of R⁴ and R⁵ independently represents an alkyl group, an aralkyl group or an aryl group, each of which may have one or more substituents. X⁻ represents SbF₆⁻, PF₆⁻, AsF₆⁻, or BF₄⁻

If the amount of catalyst included in the epoxy resin composition is too small, the temperature and time required to cure the material may become impractical. In addition, reducing the amount of catalyst too significantly will make the reaction of the cycloaliphatic epoxy and the amine curing agent incompatible. Including too much catalyst can destabilize the epoxy resin composition, making it unmanufacturable as well as increasing the risk of an uncontrolled exotherm causing the resin to overheat and burn during cure. In light of these considerations, the amount of catalyst included in the epoxy resin composition may be between 0.2 and 4 percent by weight of the total amount of epoxy resin. In one embodiment, the amount of catalyst included in the epoxy resin composition may be between 0.3 and 1.5 percent by weight of the total amount of epoxy resin ([A]+[D]).

Advantageous examples of constituent component [C] include [4-(acetyloxy)phenyl]dimethylsulfonium,(OC-6-11)-hexafluoroantimonate(1-), (4-hydroxyphenyl)dimethylsulfonium,hexafluorophosphate(1-), (4-hydroxyphenyl)methyl[(2-methylphenyl)methyl]sulfonlum,(OC-6-11)-hexafluoroantimonate(1-), (4-hydroxyphenyl)methyl(phenylmethyl)sulfonium,(OC-6-11)-hexafluoroantimonate(1-) and the like and combinations thereof.

In the present invention, the epoxy resin composition may additionally include one or more stabilizers as constituent component [E]. Such stabilizers are used in combination with the above-mentioned cationic polymerization initiator, and contribute to the storage stability of the epoxy resin composition.

Specific suitable examples of constituent component [E] include 4-(methylthio)phenol and its ether derivatives.

In the present invention, constituent component [D] is a cycloaliphatic epoxy resin represented by formula (I), wherein Y is a single bond or represents a divalent moiety having a molecular weight less than 45 g/mol

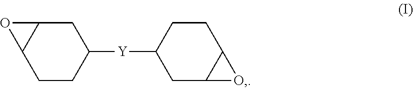

Here, a cycloaliphatic epoxy resin means an epoxy resin in which there is 1,2-epoxycycloalkane as a structural moiety. As previously stated, cycloaliphatic epoxy resins are useful because they can reduce the viscosity of the resin composition. However, typical cycloaliphatic epoxy resins, such as 3,4-epoxycyclohexylmethyl 3,4-epoxycyclohexanecarboxylate can also reduce the glass transition temperature and modulus of the cured material. To solve this problem, cycloaliphatic epoxies with shorter, more rigid linkages between 1,2-epoxycycloalkane groups are employed.

While glycidyl ether and glycidyl amine type epoxies react well with amine curing agents, cycloaliphatic epoxy resins have typically shown poor reactivity with polyamines. As disclosed in U.S. Pat. Pub. No. 20030064228, if a suitable acid catalyst is also present in the cycloaliphatic epoxy resin composition, there is coordination of a proton or Lewis acid to the oxygen atom of the epoxy groups, making them susceptible to nucleophilic substitution, and it then becomes reactive with the polyamine under practical curing conditions. This can allow the desirable reaction of the amine with the cyclic structure of the cycloaliphatic epoxy resin, resulting in molecular motion of the polymer chain being restricted and the heat resistance and modulus of elasticity of the cured material obtained are raised.

Suitable cycloaliphatic epoxy resins for purposes of the present invention may be represented by formula (I), wherein Y is a single bond or represents a divalent moiety having a molecular weight less than 45 g/mol

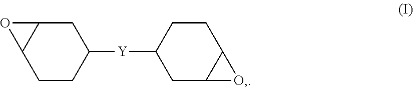

For example, the divalent moiety having a molecular weight less than 45 g/mol may be oxygen (Y=—O—), alkylene (e.g., Y=—CH₂—, —CH₂CH₂—, —CH₂CH₂CH₂—, CH₂CH(CH₃)— or —C(CH₃)₂—), an ether-containing moiety (e.g., Y=—CH₂OCH₂—), a carbonyl-containing moiety (e.g., Y=—C(═O)—), or an oxirane ring-containing moiety (e.g., Y=—CH—O—CH—, wherein a single bond exists between the two carbon atoms thereby forming a three-membered ring including the oxygen atom and the two carbon atoms).

Employing a cycloaliphatic epoxy with an aforementioned divalent moiety having a molecular weight less than 45 g/mol is advantageous, as the molecule's rigidity increases the modulus of the cured material. Furthermore, including a divalent moiety that meets the previously mentioned criteria but is also capable of forming a covalent bond with other components of the resin formulation is advantageous since increasing the crosslink density can improve both the glass transition temperature and modulus of the cured material.

Specific illustrative examples of constituent component [D] are bis(3,4-epoxycyclohexyl) (where Y is a single bond, also referred to as 3,4,3′,4′-diepoxybicyclohexyl), bis[(3,4-epoxycyclohexyl)ether] (where Y is an oxygen atom), bis[(3,4-epoxycyclohexyl)oxirane] (where Y is an oxirane ring, —CH—O—CH—), bis[(3,4-epoxycyclohexyl)methane] (where Y is methylene, CH₂), 2,2-bis(3,4-epoxycyclohexyl)propane (where Y is —C(CH₃)₂—) and the like and combinations thereof. Such cycloaliphatic epoxy resins are known in the art and may be prepared using any suitable synthetic method, including, for example, by epoxidizing cycloaliphatic di- and triolefinic compounds such as compounds having a 3,3′-dicyclohexenyl skeleton. U.S. Pat. No. 7,732,627 and U.S. Pat. Pub. Nos. 2004/0242839 and 2014/0357836, for instance, describe methods for obtaining cycloaliphatic epoxy resins useful in the present invention.

The relative amounts of component [A] and component [D] may be varied as may be desired in order to impart certain characteristics to the epoxy resin composition or to the cured epoxy resin composition or to a carbon fiber-reinforced composite material obtained by curing a prepreg comprised of carbon fiber and the epoxy resin composition. Typically, however, the epoxy resin composition will comprise at least 5 parts by weight [A] and at least 5 parts by weight [D] per 100 parts by weight in total of [A] and [D]. For example, in various embodiments of the invention the epoxy resin composition is comprised of 15 to 70 parts by weight [D] per 100 parts by weight in total of [A] and [D].

In this invention, mixing or dissolving a thermoplastic resin into the above-mentioned epoxy resin composition may also be desirable to enhance the properties of the cured material. In general, a thermoplastic resin (polymer) having bonds selected from the group consisting of carbon-carbon bonds, amide bonds, imide bonds, ester bonds, ether bonds, carbonate bonds, urethane bonds, thioether bonds, sulfone bonds and/or carbonyl bonds in the main chain is preferred. Further, the thermoplastic resin can also have a partially crosslinked structure and may be crystalline or amorphous. In particular, it is suitable that at least one thermoplastic resin selected from the group consisting of polyamides, polycarbonates, polyacetals, polyphenylene oxides, polyphenylene sulfides, polyallylatse, polyesters, polyamideimides, polyimides, polyetherimides, polylmides having a phenyltrimethylindane structure, polysulfones, polyethersulfones, polyetherketones, polyetheretherketones, polyaramids, polyethemitriles and polybenzimidazoles is mixed or dissolved into the epoxy resin composition.

In order to obtain good heat resistance, it is preferred that the glass transition temperature (Tg) of the thermoplastic resin is at least 150° C. or higher, or more preferably 170° C. or higher. If the glass transition temperature of the mixed thermoplastic resin is lower than 150° C., the cured article obtained may be likely to be deformed by heat when it is used. Further, a thermoplastic resin having hydroxyl groups, carboxyl groups, thiol groups, acid anhydride or the like as the end functional groups can be preferably used, since it can react with a cationically polymerizable compound.

Specific examples are polyethersulfones and the polyethersulfone-polyetherethersulfone copolymer oligomers as described in JP2004-506789 A; commercially available products of the polyetherimide type, etc. can also be used. An oligomer refers to a polymer with a relatively low molecular weight in which a finite number of approximately ten to approximately 100 monomer molecules are bonded to each other.

Although the epoxy resin composition need not contain thermoplastic resin, in various embodiments of the invention the epoxy resin composition is comprised of at least 5 or at least 10 parts by weight thermoplastic resin per 100 parts by weight in total of component [A] and component [D]. For example, the epoxy resin composition may be comprised of from 10 to 30 parts by weight thermoplastic resin per 100 parts by weight in total of component [A] and component [D].

In the present invention, the epoxy resin composition may have a viscosity increase of less than 200% of the starting viscosity when held at 65° C. for 2 hours. Such a characteristic is advantageous from the viewpoint of the manufacturability of fiber-reinforced prepregs. In the present invention, viscosity refers to the complex viscoelastic modulus n* as measured at a frequency of 0.5 Hz and a gap length of 1 mm using a dynamic viscoelastic measuring device (ARES, manufactured by TA Instruments) and circular parallel plates 40 mm in diameter as the temperature is monotonically increased at a rate of 2° C./min. The “viscosity increase” of the resin is measured using the same geometry and instrument and holding the temperature at 65° C. for two hours. The viscosity increase is calculated using the equation below:

Viscosity increase=((n*final/n*initial)−1)*100
n* initial is the initial viscosity of the resin at 65° C.
n* final is the final viscosity of the resin after two hours at 65° C.

If the viscosity increase is less than 200% over two hours, the latency is considered acceptable from the viewpoint of the manufacturability of fiber-reinforced prepregs.

The physical properties of cured resins such as resin modulus, strength and toughness are affected by the thermal history during curing. This is especially important for the molding of large components of composite parts because the thermal history can vary within the part due to inhomogeneity of temperature distribution in the molding machine. Having an epoxy resin system with a substantially singular reaction peak as measured by differential scanning calorimetry (DSC) under a ramp rate of 10° C./min ensures that the potential for phase separation of the epoxy resin composition does not occur during cure and that the cured resin has consistent properties.

As previously stated, if a suitable acid catalyst, constituent component [C], is present together with a cycloaliphatic epoxy component [D], then the cycloaliphatic epoxy becomes reactive with the polyamine. This can allow the desirable reaction of the amine with the cyclic structure of the cycloaliphatic epoxy resin. Due to the amine's ability to react with the cycloaliphatic epoxy under these conditions, it now becomes possible to compatibilize the cycloaliphatic epoxy [D] with the epoxy resin [A]. This interaction facilitates the sequential reactions in the system resulting in the epoxy resin composition having characteristics wherein |T₁−T₂|<170° C., and more preferably |T₁−T₂|<120° C. T₁ is the temperature corresponding to the primary reaction peak in the DSC curve measured for the mixture of [A] and [B], and T₂ is the temperature corresponding to the primary reaction peak in the DSC curve measured for the mixture of [C] and [D].

The ability of the catalyst to quickly cure the cycloaliphatic epoxy at low temperatures gives the epoxy resin composition low temperature curability. However, this reaction has a significant reaction exotherm in a narrow temperature range increasing the risk of an uncontrolled exotherm, causing the resin to overheat and burn during cure. Therefore, if 40° C.<|T₁−T₂|, and more preferably 70° C.<|T₁−T₂|, then the epoxy resin composition can be cured quickly at low temperatures without the risk of uncontrolled exotherms.

The mechanical properties of the fiber-reinforced composite material are influenced by the various properties of the matrix.

The elastic modulus of the matrix influences the fiber-direction compressive strength and tensile strength of the fiber-reinforced composite material, and the higher the value thereof the better. Consequently, it is preferred that the cured product of the epoxy resin composition of the present invention has a high elastic modulus. Specifically, it is preferred that the flexural modulus of elasticity of the cured material obtained by curing the epoxy resin composition be at least 3.5 GPa.

The glass transition temperature of the matrix influences the heat resistance of the fiber-reinforced composite material. It is preferred that the cured product of the epoxy resin composition of the present invention has a high glass transition temperature. Specifically, it is preferred that the glass transition temperature of the cured material obtained be at least 210° C.

In the preparation of the epoxy resin composition of the present invention, a kneader, planetary mixer, triple roll mill, twin screw extruder, and the like may advantageously be used. After the epoxy resins are placed in the equipment, the mixture is heated to a temperature in the range of from 80 to 180° C. while being stirred so as to uniformly dissolve the epoxy resins. During this process, other components, excluding the curing agent(s), (e.g., thermoplastic, inorganic particles) may be added to the epoxy resins and kneaded with them. After this, the mixture is cooled down to a temperature of no more than 100° C. in some embodiments, no more than 80° C. in other embodiments or no more than 60° C. in still other embodiments, while being stirred, followed by the addition of the curing agent(s) and kneading to disperse those components. This method may be used to provide an epoxy resin composition with excellent storage stability.

Next, FRP materials are described. By curing embodiments of the epoxy resin composition after impregnating reinforcing fibers with it, a FRP material that contains, as its matrix resin, embodiments of the epoxy resin composition in the form of a cured product may be obtained.

There are no specific limitations or restrictions on the type of reinforcing fiber used in the present invention, and a wide range of fibers, including glass fiber, carbon fiber, graphite fiber, aramid fiber, boron fiber, alumina fiber and silicon carbide fiber, may be used. Carbon fiber may provide FRP materials that are particularly lightweight and stiff. Carbon fibers with a tensile modulus of 180 to 800 GPa may be used, for example. If a carbon fiber with a high modulus of 180 to 800 GPa is combined with an epoxy resin composition of the present invention, a desirable balance of stiffness, strength and impact resistance may be achieved in the FRP material.

There are no specific limitations or restrictions on the form of reinforcing fiber, and fibers with diverse forms may be used, including, for instance, long fibers (drawn in one direction), tow, fabrics, mats, knits, braids, and short fibers (chopped into lengths of less than 10 mm). Here, long fibers mean single fibers or fiber bundles that are effectively continuous for at least 10 mm. Short fibers, on the other hand, are fiber bundles that have been chopped into lengths of less than 10 mm. Fiber configurations in which reinforcing fiber bundles have been aligned in the same direction may be suitable for applications where a high specific strength and specific modulus are required.

FRP materials of the present invention may be manufactured using methods such as the prepreg lamination and molding method, resin transfer molding method, resin film infusion method, hand lay-up method, sheet molding compound method, filament winding method and pultrusion method, though no specific limitations or restrictions apply in this respect.

Resin transfer molding is a method in which a reinforcing fiber base material is directly impregnated with a liquid thermosetting resin composition and cured. Since this method does not involve an intermediate product, such as a prepreg, it has great potential for molding cost reduction and is advantageously used for the manufacture of structural materials for spacecraft, aircraft, rail vehicles, automobiles, marine vessels and so on.

Prepreg lamination and molding is a method in which a prepreg or prepregs, produced by impregnating a reinforcing fiber base material with a thermosetting resin composition, is/are formed and/or laminated, followed by the curing of the resin through the application of heat and pressure to the formed and/or laminated prepreg/prepregs to obtain a FRP material.

Filament winding is a method in which one to several tens of reinforcing fiber rovings are drawn together in one direction and impregnated with a thermosetting resin composition as they are wrapped around a rotating metal core (mandrel) under tension at a predetermined angle. After the wraps of rovings reach a predetermined thickness, it is cured and then the metal core is removed.

Pultrusion is a method in which reinforcing fibers are continuously passed through an impregnating tank filled with a liquid thermosetting resin composition to impregnate them with the thermosetting resin composition, followed by a squeeze die and heating die for molding and curing, by continuously drawing them using a tensile machine. Since this method offers the advantage of continuously molding FRP materials, it is used for the manufacture of FRP materials for fishing rods, rods, pipes, sheets, antennas, architectural structures, and so on.

Of these methods, the prepreg lamination and molding method may be used to give excellent stiffness and strength to the FRP materials obtained.

Prepregs may contain embodiments of the epoxy resin composition and reinforcing fibers. Such prepregs may be obtained by impregnating a reinforcing fiber base material with an epoxy resin composition of the present invention. Impregnation methods include the wet method and hot melt method (dry method).

The wet method is a method in which reinforcing fibers are first immersed in a solution of an epoxy resin composition, created by dissolving the epoxy resin composition in a solvent, such as methyl ethyl ketone or methanol, and retrieved, followed by the removal of the solvent through evaporation via an oven, etc. to impregnate reinforcing fibers with the epoxy resin composition. The hot-melt method may be implemented by impregnating reinforcing fibers directly with an epoxy resin composition, made fluid by heating in advance, or by first coating a piece or pieces of release paper or the like with an epoxy resin composition for use as resin film and then placing a film over one or either side of reinforcing fibers as configured into a flat shape, followed by the application of heat and pressure to impregnate the reinforcing fibers with the resin. The hot-melt method may give the prepreg having virtually no residual solvent in it.

The reinforcing fiber cross-sectional density of a prepreg may be 50 to 350 g/m². If the cross-sectional density is at least 50 g/m², there may be a need to laminate a small number of prepregs to secure the predetermined thickness when molding a FRP material and this may simplify lamination work. If, on the other hand, the cross-sectional density is no more than 350 g/m², the drapability of the prepreg may be good. The reinforcing fiber mass fraction of a prepreg may be 50 to 90 mass % in some embodiments, 60 to 85 mass % in other embodiments or even 70 to 80 mass % in still other embodiments. If the reinforcing fiber mass fraction is at least 50 mass %, there is sufficient fiber content, and this may provide the advantage of a FRP material in terms of its excellent specific strength and specific modulus, as well as preventing the FRP material to generate too much heat during the curing time. If the reinforcing fiber mass fraction is no more than 90 mass %, impregnation with the resin may be satisfactory, decreasing a risk of a large number of voids forming in the FRP material.

To apply heat and pressure under the prepreg lamination and molding method, the press molding method, autoclave molding method, bagging molding method, wrapping tape method, internal pressure molding method, or the like may be used as appropriate.

Autoclave molding is a method in which prepregs are laminated on a tool plate of a predetermined shape and then covered with bagging film, followed by curing, performed through the application of heat and pressure while air is drawn out of the laminate. It may allow precision control of the fiber orientation, as well as providing high-quality molded materials with excellent mechanical characteristics, due to a minimum void content. The pressure applied during the molding process may be 0.3 to 1.0 MPa, while the molding temperature may be in the 90 to 300° C. range. Due to the exceptionally high Tg of the cured epoxy resin composition of the present invention, it may be advantageous to carry out curing of the prepreg at a relatively high temperature (e.g., a temperature of at least 180° C. or at least 200° C.). For example, the molding temperature may be from 200° C. to 275° C. Alternatively, the prepreg may be molded at a somewhat lower temperature (e.g., 90° C. to 200° C.), demolded, and then post-cured after being removed from the mold at a higher temperature (e.g., 200° C. to 275° C.).

The wrapping tape method is a method in which prepregs are wrapped around a mandrel or some other cored bar to form a tubular FRP material. This method may be used to produce golf shafts, fishing poles and other rod-shaped products. In more concrete terms, the method involves the wrapping of prepregs around a mandrel, wrapping of wrapping tape made of thermoplastic film over the prepregs under tension for the purpose of securing the prepregs and applying pressure to them. After curing of the resin through heating inside an oven, the cored bar is removed to obtain the tubular body. The tension used to wrap the wrapping tape may be 20 to 100 N. The molding temperature may be in the 80 to 300° C. range.

The internal pressure forming method is a method in which a preform obtained by wrapping prepregs around a thermoplastic resin tube or some other internal pressure applicator is set inside a metal mold, followed by the introduction of high pressure gas into the internal pressure applicator to apply pressure, accompanied by the simultaneous heating of the metal mold to mold the prepregs. This method may be used when forming objects with complex shapes, such as golf shafts, bats, and tennis or badminton rackets. The pressure applied during the molding process may be 0.1 to 2.0 MPa. The molding temperature may be between room temperature and 300° C. or in the 180 to 275° C. range.

The FRP material produced from the prepreg of the present invention may have a class A surface as mentioned above. The class A surface means the surface that exhibit extremely high finish quality characteristics free of aesthetic blemishes and defects.

FRP materials that contain cured epoxy resin compositions obtained from epoxy resin compositions of the present invention and reinforcing fibers are advantageously used in sports applications, general industrial applications, and aeronautic and space applications. Concrete sports applications in which these materials are advantageously used include golf shafts, fishing rods, tennis or badminton rackets, hockey sticks and ski poles. Concrete general industrial applications in which these materials are advantageously used include structural materials for vehicles, such as automobiles, bicycles, marine vessels and rail vehicles, drive shafts, leaf springs, windmill blades, pressure vessels, flywheels, papermaking rollers, roofing materials, cables, and repair/reinforcement materials.

With respect to mechanical properties of carbon fiber-reinforced composite materials, although the tensile strength has been greatly increased as the tensile strength of carbon fibers increases, increase of the compressive strength is small even if high tensile-strength fibers are used instead of standard tensile-strength fibers. Accordingly, flexural strength is important for practical uses, which is determined by the compressive strength because it is smaller than the tensile strength. Therefore, the compressive strength is very important for uses of structural materials on which compressive or flexural stress is applied. Particularly, the compressive strength is an extremely important property for use as a primary structure material. Further, in the case of an aircraft, since there are many bolt holes, open hole compressive strength becomes important.

Further, because mechanical properties, particularly the compressive strength, are greatly decreased under hot-wet conditions (H/W), open hole compressive strength under hot-wet conditions becomes very important. When considering the open hole compressive strength at 180° C. under hot-wet conditions, both the glass transition temperature and the modulus of the cured matrix material are essential because OHC is a resin dominant property.

### EXAMPLES

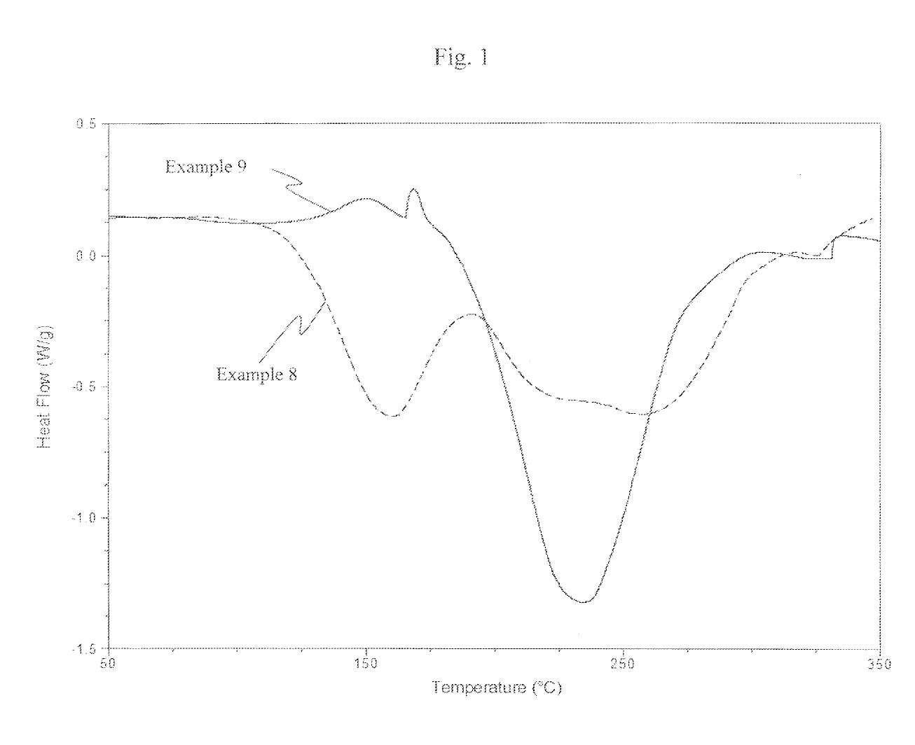

In the examples of the present invention, the measurements of the properties were based on the methods described below. The details for each of the examples are shown in Table 1, Table 2 and FIG. 1.

### <Epoxy Resin Viscosity>

A mixture was created by dissolving the prescribed amounts of all the components other than the curing agent and the curing catalyst in a mixture. Then the prescribed amounts of the curing agent and catalyst were mixed into the mixture to obtain the epoxy resin composition.

The viscosity of the epoxy resin composition was measured using a dynamic viscoelasticity measuring device (ARES, manufactured by TA Instruments) using parallel plates while simply increasing the temperature at a rate of 2° C./min, with a strain of 10%, frequency of 0.5 Hz, and plate gap of 1 mm, and plate dimensions of 40 mm, from 50° C. to 170° C. In the present invention, viscosity refers to the complex viscoelastic modulus n*.

The “viscosity increase” of the resin is measured by setting the parameters of the viscoelastic device (ARES, manufactured by TA Instruments) per the same method for viscosity measurement and holding the temperature isothermally at 65° C. for two hours. The viscosity increase is calculated using the equation below:

Viscosity Increase=n*final/n*initial
n*initial is the initial viscosity of the resin at 65° C.
n*final is the final viscosity of the resin after two hours at 65° C.

### <Resin Plaque Preparation>

A mixture was created by dissolving the prescribed amounts of all the components other than the curing agent and the curing catalyst in a mixture. Then the prescribed amounts of the curing agent and catalyst were mixed into the mixture to obtain the epoxy resin composition. The epoxy resin composition was dispensed into a mold cavity set for a thickness of 2 mm using a 2 mm-thick polytetrafluoroethylene (PTFE) spacer. Then, the epoxy resin composition was cured by heat treatment in an oven under the various cure conditions to obtain a 2 mm-thick cured resin plaque.

### Condition 1

(1) temperature raised at a rate of 1.5° C./min from room temperature to 110° C.;
(2) hold for one hour at 110° C.;
(3) temperature raised at a rate of 1.5° C./min from 110° C. to 210° C.;
(4) hold for two hours at 210° C.; and
(5) temperature lowered from 210° C. to 30° C. at a rate of 3° C./min.

### Condition 2

(1) temperature raised at a rate of 1.5° C./min from room temperature 25° C. to 90° C.;
(2) hold for one hours at 90° C.;
(3) temperature raised at a rate of 1.5° C./min from 90° C. to 210° C.;
(4) hold for two hours at 210° C.; and
(5) temperature lowered from 210° C. to 30° C. at a rate of 3° C./min.

### Condition 3

(1) temperature raised at a rate of 1.5° C./min from room temperature 25° C. to 140° C.;
(2) hold for one hours at 140° C.;
(3) temperature raised at a rate of 1.5° C./min from 140° C. to 210° C.;
(4) hold for two hours at 210° C.; and
(5) temperature lowered from 210° C. to 30° C. at a rate of 3° C./min.

### <Glass Transition Temperature of Cured Epoxy Resin Compositions>

Specimens were machined from the cured two mm resin plaque, and then measured at 1.0 in Hz torsion mode using a dynamic viscoelasticity measuring device (ARES, manufactured by TA Instruments) by heating it from 50° C. to 250° C. at a rate of 5° C./min in accordance with SACMA SRM 18R-94. Tg was determined by finding the intersection between the tangent line of the glassy region and the tangent line of the transition region between the glassy region and the rubbery region on the temperature-elastic storage modulus curve. The temperature at that intersection was considered to be the glass transition temperature, commonly referred to as G′ onset Tg.

### <Flexural Testing of Cured Epoxy Resin Compositions>

Specimens were machined from the cured two mm resin plaque and the flexural modulus of elasticity and strength of the cured resin sheet were measured in accordance with ASTM D-790.

### <Production of Fiber-Reinforced Composite Material>

A mixture was created by dissolving the prescribed amounts of all the components, other than the curing agent and the curing catalyst, in a mixture. Then the prescribed amounts of the curing agent and catalyst were mixed into the mixture to obtain the epoxy resin composition. The produced epoxy resin composition was applied onto release paper using a knife coater to produce 2 sheets of resin film. Next, the aforementioned two sheets of fabricated resin film were overlaid on both sides of unidirectionally oriented carbon fibers and the resin was impregnated using heated rollers to apply temperature and pressure to produce a unidirectional prepreg.

### <Measurement of the Open Hole Tensile Strength of the Fiber-Reinforced Composite Material>

Eight plies of unidirectional prepreg were laminated in a [+45, 0, −45, 90]ₛ structure and degassed at 25° C. and a degree of vacuum of 75 KPa. The body was then placed in an autoclave with the degree of vacuum being maintained at 75 KPa until the autoclave was pressurized to 138 KPa at which point the vacuum bag was vented until the end of the cure. When the autoclave pressure reached 586 KPa the temperature was increased at a rate of 1.5° C. to a temperature of 180° C. and maintained for 120 minutes to cure the prepreg and produce a laminate body 350 mm long and 350 mm wide. The laminate body was then post cured in a convection oven by increasing the temperature at a rate of 1.5° C. to a temperature of 210° C. and maintained for 120 minutes. The tensile strength of the fiber-reinforced composite material was determined from this laminate body in accordance with ASTM D5766.

### <Measurement of the 180° C. Open Hole Tensile Strength of the Fiber-Reinforced Composite Material>

Eight plies of unidirectional prepreg were laminated in a [+45, 0, −45, 90]ₛ structure and degassed at 25° C. and a degree of vacuum of 75 KPa. The body was then placed in an autoclave with the degree of vacuum being maintained at 75 KPa until the autoclave was pressurized to 138 KPa, at which point the vacuum bag was vented until the end of the cure. When the autoclave pressure reached 586 KPa the temperature was increased at a rate of 1.5° C. to a temperature of 180° C. and maintained for 120 minutes to cure the prepreg and produce a laminate body 350 mm long and 350 mm wide. The laminate body was then post cured in a convection oven by increasing the temperature at a rate of 1.5° C. to a temperature of 210° C. and maintained for 120 minutes. The tensile strength of the fiber-reinforced composite material was determined from this laminate body in accordance with ASTM D5766 at 180° C.

### <Measurement of the Open Hole Compressive Strength of the Fiber-Reinforced Composite Material>

Sixteen plies of unidirectional prepreg were laminated in a [+45, 0, −45, 90]₂ₛ structure and degassed at 25° C. and a degree of vacuum of 75 KPa. The body was then placed in an autoclave with the degree of vacuum being maintained at 75 KPa until the autoclave was pressurized to 138 KPa at which point the vacuum bag was vented until the end of the cure. When the autoclave pressure reached 586 KPa, the temperature was increased at a rate of 1.5° C. to a temperature of 180° C. and maintained for 120 minutes to cure the prepreg and produce a laminate body 350 mm long and 350 mm wide. The laminate body was then post cured in a convection oven by increasing the temperature at a rate of 1.5° C. to a temperature of 210° C. and maintained for 120 minutes. The compressive strength of the fiber-reinforced composite material was determined from this laminate body in accordance with ASTM D6484.

### <Measurement of the 180° C. Hot/Wet Open Hole Compressive Strength of the Fiber-Reinforced Composite Material>

Sixteen plies of unidirectional prepreg were laminated in a [+45, 0, −45, 90]₂ₛ structure and degassed at 25° C. and a degree of vacuum of 75 KPa. The body was then placed in an autoclave with the degree of vacuum being maintained at 75 KPa until the autoclave was pressurized to 138 KPa at which point the vacuum bag was vented until the end of the cure. When the autoclave pressure reached 586 KPa, the temperature was increased at a rate of 1.5° C. to a temperature of 180° C. and maintained for 120 minutes to cure the prepreg and produce a laminate body 350 mm long and 350 mm wide. The laminate body was then post cured in a convection oven by increasing the temperature at a rate of 1.5° C. to a temperature of 210° C. and maintained for 120 minutes. Once the specimens were machined in accordance with ASTM D6484 they were immersed in 70° C. deionized water for two weeks. The compressive strength of the fiber-reinforced composite material was determined from this laminate body in accordance with ASTM D6484 at 180° C.

### <Raw Materials>

The following commercial products were employed in the preparation of the epoxy resin composition.

### Carbon Fibers

Torayca T800S-24K-10E (registered trademark, produced by Toray with a fiber count of 24,000, tensile strength of 588,000 MPa, tensile elasticity of 294 GPa, and tensile elongation of 2.0%).

### Constituent Component [A]:

“Tactix” 742 (registered trademark, produced by the Huntsman Corporation), the triglycidyl ether of tris(p-hydroxyphenyl)methane;
“Araldite” MY 721 (registered trademark, produced by the Huntsman Corporation), N,N,N′,N′-tetraglycidyl-4,4′-diaminodiphenylmethane;
“Araldite” MY 0610 (registered trademark, produced by the Huntsman Corporation), triglycidyl-m-aminophenol;
“Araldite” MY 0816 (registered trademark, produced by the Huntsman Corporation), the diglycidyl ether of 1,6-dihydroxynaphthalene;
“Epiclon” HP-4710 (registered trademark, produced by the DIC Corporation), the tetraglycidyl ether of 1,6-bis(2-naphthyl)methane.

### Constituent Component [B]:

“Aradur” 9664-1 (registered trademark, produced by the Huntsman Corporation), 4,4′-diaminodiphenylsulfone;
“Aradur” 9719-1 (registered trademark, produced by the Huntsman Corporation), 3,3′-diaminodiphenylsulfone.

### Constituent Component [C]:

“San-Aid” SI-110 (registered trademark, produced by the SANSHIN CHEMICAL INDUSTRY CO., LTD), (4-hydroxyphenyl)methyl(phenylmethyl)sulfonium, hexafluorophosphate(1-);
“San-Aid” SI-150 (registered trademark, produced by the SANSHIN CHEMICAL INDUSTRY CO., LTD), [4-(acetyloxy)phenyl]dimethylsulfonium,(OC-6-11)-hexafluoroantimonate(1-);
“San-Aid” SI-180 (registered trademark, produced by the SANSHIN CHEMICAL INDUSTRY CO., LTD), (4-hydroxyphenyl)dimethylsulfonium,hexafluorophosphate(1-).

### Constituent Component [D]:

“Celloxide” 2021P (registered trademark, produced by Daicel Chemical Industries), 3,4-epoxycyclohexylmethyl 3,4-epoxycyclohexanecarboxylate;
“Celloxide” 8000 (registered trademark, produced by Daicel Chemical Industries), bis(3,4-epoxycyclohexyl); “Celloxide” 8200 (registered trademark, produced by Daicel Chemical Industries).

### Examples 1 Through 7, Examples 10 and 12, Comparative Examples 2 Through 5

The resin composition as shown in Table 1 was produced. Here a mixture was created by dissolving the prescribed amounts of all the components, other than the curing agent and the curing catalyst, in a mixture. Then the prescribed amounts of the curing agent and catalyst were mixed into the mixture to obtain the epoxy resin composition. The epoxy resin composition was dispensed into a mold cavity set for a thickness of 2 mm using a 2 mm-thick polytetrafluoroethylene (PTFE) spacer. Then, the epoxy resin composition was cured according to condition 1 by heat treatment in an oven under the various cure conditions to obtain a 2 mm-thick cured resin plaque. The measured properties of the neat resin compositions are stated in Table 1.

### Examples 8, 9, 11 and 13 as Well as Comparative Example 1

The resin composition as shown in Table 1 was produced. Here a mixture was created by dissolving the prescribed amounts of all the components other than the curing agent and the curing catalyst in a mixture. Then the prescribed amounts of the curing agent and catalyst were mixed into the mixture to obtain the epoxy resin composition. The epoxy resin composition was dispensed into a mold cavity set for a thickness of 2 mm using a 2 mm-thick polytetrafluoroethylene (PTFE) spacer. Then, the epoxy resin composition was cured according to condition 1 by heat treatment in an oven under the various cure conditions to obtain a 2 mm-thick cured resin plaque. The measured properties of the neat resin compositions are stated in Table 1.

Composite properties were measured by applying the resin composition onto release paper using a knife coater to produce two sheets of 51.7 g/m² resin film. Next, the aforementioned two sheets of fabricated resin film were overlaid on both sides of unidirectionally oriented carbon fibers in the form of a sheet (T800S-24K-10E) and the resin was impregnated using a roller temperature of 100° C. and a roller pressure of 0.07 MPa to produce a unidirectional prepreg with a carbon fiber area weight of 190 g/m² and a matrix resin weight content of 35%. The epoxy resin composition content in the prepreg, the open hole tensile strength of the fiber-reinforced composite material, the open hole tensile strength of the fiber-reinforced composite material at 180° C., the open hole compressive strength of the fiber-reinforced composite material, and the open hole compressive strength of the fiber-reinforced composite material at 180° C. H/W, were measured using the unidirectional prepreg that was produced. The results obtained are shown in Table 1.

Examples 1 to 13 provided good results compared with comparative example 1 in terms of processability, heat resistance and modulus. Comparison between example 13 and comparative example 1 highlights this advantage, demonstrating that a substitution of just 20 parts of “Celloxide” 8000, a cycloaliphatic epoxy, for EPON 825, a bisphenol A epoxy resin, resulted in significant improvements in the aforementioned properties.

While comparative examples 2 through 5 are stable enough to make prepreg, unlike comparative example 1 they do not have a high enough glass transition temperature to be used at 180° C. under H/W conditions.

DSC curves of the epoxy resin composition for example 8 and example 9 are shown in FIG. 1. The epoxy resin compositions of examples 8 and 9 were cured under conditions 1 to 3 and tested for flexural properties. The results are shown in Table 2. Example 9 with the ideal difference in temperature between T₁ and T₂ exhibited a single reaction peak in its DSC curve as shown in FIG. 1, and was shown to have consistent flexural strength with respect to varying cure conditions as shown in Table 2.

Example 11 demonstrates that using “Celloxide” 8200, a cycloaliphatic epoxy with a different structure than “Celloxide” 8000 but still having a low molecular weight linkage with a molecular weight less than 45 g/mol, still gives a resin composition providing good results when compared with comparative examples in terms of processability, heat resistance and modulus.

Considering notched composite properties, examples 8, 9, 11 and 13 all exhibit superior performance relative to comparative example 1 in both OHT and OHC under all conditions tested in Table 1. The combination of both high glass transition temperature and modulus exhibited in the neat resin contributed to their superior performance.

TABLE 1

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Epoxy resin | Araldite ® MY 0816 | 70 | 70 | 70 | 70 | 60 | | | | |
| [A] | Epiclon ® HP-4710 | | | | | | 40 | | | |
| | Araldite ® MY 0610 | | | | | | | 70 | | |
| | Araldite ® MY 721 | | | | | 20 | | | 60 | 60 |
| | Tactix ® 742 | | | | | | | | | |
| | EPON ® 825 | | | | | | | | | |
| Curing agent | Aradur ® 9664-1 | 30 | 30 | 30 | 30 | 36 | 15 | 44 | 33 | 33 |
| [B] | Epicure ® W | | | | | | | | | |
| Catalyst | SAN-AID ® SI-110L | 1 | 1 | | | | | | | |
| [C] | SAN-AID ® SI-150 | | | 1 | | 1 | 1 | 1 | 1 | |
| | SAN-AID ® SI-180 | | | | 1 | | | | | 0.5 |
| | BF₃/piperidine | | | | | | | | | |
| | complex | | | | | | | | | |
| Epoxy resin | Celloxide ® 8000 | 30 | 30 | 30 | 30 | 20 | 60 | 30 | 40 | 40 |
| [D] | Celloxide ® 8200 | | | | | | | | | |
| | Celloxide ® 2021P | | | | | | | | | |
| Thermoplastic | Virantage ® | | 25 | 25 | 25 | 15 | 15 | 25 | 25 | 25 |
| resin | VW10700 | | | | | | | | | |
| Resin | Viscosity increase | 40 | 10 | 5 | 5 | 5 | 18 | 11 | 25 | 15 |
| Properties | for 2 hr at 65° C. (%) | | | | | | | | | |
| (Condition 1) | Glass Transition | 210 | 210 | 212 | 215 | 215 | 221 | 210 | 225 | 220 |
| | temperature (° C.) | | | | | | | | | |
| | Flexural modulus | 3.6 | 3.8 | 3.9 | 3.6 | 4.0 | 3.7 | 4.1 | 4.0 | 4.0 |
| | of elasticity (GPa) | | | | | | | | | |
| Composite | Open Hole Tensile | | | | | | | 476 | 469 | |
| properties | Strength (MPa) | | | | | | | | | |
| | Open Hole | | | | | | | 545 | 525 | |
| | Tensile Strength | | | | | | | | | |
| | 180° C. (MPa) | | | | | | | | | |
| | Open Hole | | | | | | | 290 | 290 | |
| | Compressive | | | | | | | | | |
| | Strength (MPa) | | | | | | | | | |
| | Open Hole | | | | | | | 159 | 165 | |
| | Compressive | | | | | | | | | |
| | Strength 180° C. | | | | | | | | | |
| | H/W (MPa) | | | | | | | | | |
| | | Example | Example | Example | Example | Comparative | Comparative | Comparative | Comparative | Comparative |
| | | 10 | 11 | 12 | 13 | example 1 | example 2 | example 3 | example 4 | example 5 |
| Epoxy resin | Araldite ® MY 0816 | | | | | | | | | |
| [A] | Epiclon ® HP-4710 | | | | | | | | | |
| | Araldite ® MY 0610 | | | | | | | | | |
| | Araldite ® MY 721 | 60 | | | 20 | 20 | 50 | 50 | 60 | 60 |
| | Tactix ® 742 | | 60 | 60 | 60 | 60 | | | | |
| | EPON ® 825 | | | | | 20 | | | | |
| Curing agent | Aradur ® 9664-1 | 33 | 24 | 24 | 33 | 40 | | | 30 | 30 |
| [B] | Epicure ® W | | | | | | 36.3 | 36.3 | | |
| Catalyst | SAN-AID ® SI-110L | | | | | | | | | |
| [C] | SAN-AID ® SI-150 | 1 | 1 | 1 | 1 | | | | | |
| | SAN-AID ® SI-180 | | | | | | | | | 1 |
| | BF₃/piperidine | | | | | | 4.9 | 1 | 1 | |
| | complex | | | | | | | | | |
| Epoxy resin | Celloxide 8000 | | 40 | | 20 | | | | 40 | |
| [D] | Celloxide 8200 | 40 | | 40 | | | | | | |
| | Celloxide 2021P | | | | | | 50 | 50 | | 40 |
| Thermoplastic | Virantage ® | 25 | 25 | 25 | 15 | 15 | 15 | 23 | 25 | 25 |
| resin | VW10700 | | | | | | | | | |
| Resin | Viscosity increase | 25 | 20 | 20 | 5 | 5 | 500 | 20 | 30 | 8 |
| Properties | for 2 hr at 65° C. (%) | | | | | | | | | |
| (Condition 1) | Glass Transition | 224 | 232 | 224 | 226 | 215 | 225 | 205 | 211 | 198 |
| | temperature (° C.) | | | | | | | | | |
| | Flexural modulus of | 3.8 | 3.6 | 3.6 | 4.0 | 2.9 | 3.8 | 3.5 | 3.6 | 3.4 |
| | elasticity (GPa) | | | | | | | | | |
| Composite | Open Hole Tensile | | 483 | | 476 | 469 | | | | |
| properties | Strength (MPa) | | | | | | | | | |
| | Open Hole Tensile | | 490 | | 490 | 483 | | | | |
| | Strength 180° C. | | | | | | | | | |
| | (MPa) | | | | | | | | | |
| | Open Hole | | 255 | | 276 | 179 | | | | |
| | Compressive | | | | | | | | | |
| | Strength (MPa) | | | | | | | | | |
| | Open Hole | | | | | | | | | |
| | Compressive | | | | | | | | | |
| | Strength 180° C. | | 186 | | 172 | 124 | | | | |
| | H/W (MPa) | | | | | | | | | |

TABLE 2

| | | Example 8 | Example 9 |
|---|---|---|---|
| Epoxy resin [A] | Araldite ® MY 0816 | | |
| | Epiclon ® HP-4710 | | |
| | Araldite ® MY 0610 | | |
| | Araldite ® MY 721 | 60 | 60 |
| | Tactix ® 742 | | |
| | EPON ® 825 | | |
| Curing agent [B] | Aradur ® 9664-1 | 33 | 33 |
| | Epicure ® W | | |
| Catalyst [C] | SAN-AID ® SI-110L | | |
| | SAN-AID ® SI-150 | 1 | |
| | SAN-AID ® SI-180 | | 0.5 |
| | BF₃/piperidine complex | | |
| Epoxy Resin [D] | Celloxide ® 8000 | 40 | 40 |
| | Celloxide ® 2021P | | |
| Thermoplastic resin | Virantage ® VW10700 | 25 | 25 |
| Reaction parameter | T₁ (° C.) | 230 | 230 |
| | T₂ (° C.) | 130 | 160 |
| | \|T₁ − T₂\| (° C.) | 100 | 70 |
| Flexural Strength | Cure condition 1 | 165 | 175 |
| (MPa) | Cure condition 2 | 165 | 170 |
| | Cure condition 3 | 140 | 180 |

1. An epoxy resin composition for a fiber-reinforced composite material, comprising the following constituent components [A], [B], [C], and [D]:
[A] at least one epoxy resin other than a cycloaliphatic epoxy resin represented by formula (I);
[B] at least one amine curing agent;
[C] at least one latent acid catalyst; and
[D] at least one cycloaliphatic epoxy resin represented by formula (I), wherein Y is a single bond or represents a divalent moiety having a molecular weight less than 45 g/mol

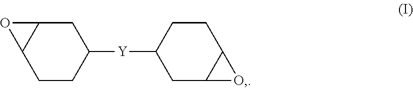

2. An epoxy resin composition according to claim 1, wherein [C] includes at least one onium salt catalyst.

3. An epoxy resin composition according to claim 1, wherein [C] includes at least one onium salt catalyst represented by formula (II): 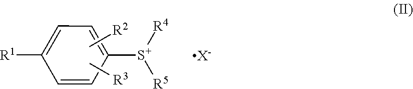
wherein R¹ represents a hydrogen atom, a hydroxyl group, an alkoxyl group, or a group represented by formula (III):
Y′—C(═O)—O— (III)
wherein Y′ represents an alkyl group, an alkoxyl group, a phenyl group or a phenoxy group, all of which may have one or more substituents, each of R² and R³ independently represents a hydrogen atom, a halogen atom, or an alkyl group, each of R⁴ and R⁵ independently represents an alkyl group, an aralkyl group or an aryl group, each of which may have one or more substituents, and X⁻ represents SbF₆⁻, PF₆⁻, AsF₆⁻, or BF₄⁻.

4. An epoxy resin composition according to claim 1, wherein [A] includes at least one aromatic epoxy resin with two or more epoxy functionalities.

5. An epoxy resin composition according to claim 1, wherein [A] includes at least one epoxy resin containing one or more naphthalene moieties.

6. An epoxy resin composition according to claim 5, wherein the amount of [A] is 40 to 80 percent by weight of the total amount of epoxy resin in the epoxy resin composition.

7. An epoxy resin composition according to claim 1, wherein [A] includes at least one epoxy resin selected from the group consisting of triglycidyl ethers of tris(p-hydroxyphenyl)methane, N,N,N′,N′-tetraglycidyl-4,4′-diaminodiphenylmethane, triglycidyl-m-aminophenol, diglycidyl ethers of 1,6-dihydroxynaphthalene, and tetraglycidyl ethers of 1,6-bis(2-naphthyl)methane.

8. An epoxy resin composition according to claim 1, wherein the epoxy resin composition exhibits a viscosity increase of less than 200% after two hours at 65° C.

9. An epoxy resin composition according to claim 1, wherein the difference in temperature between T₁ and T₂ is between 40 and 170° C., T₁ being the temperature corresponding to the primary reaction peak in the DSC curve measured for the mixture of [A] and [B], and T₂ being the temperature corresponding to the primary reaction peak in the DSC curve measured for the mixture of [C] and [D].

10. An epoxy resin composition according to claim 9, wherein the difference in temperature between T₁ and T₂ is between 70 and 120° C.

11. An epoxy resin composition according to claim 8, wherein the epoxy resin composition has a substantially singular reaction peak in the DSC curve under a ramp rate of 10° C./min.

12. An epoxy resin composition according to claim 1, additionally comprising at least one thermoplastic resin.

13. An epoxy resin composition according to claim 1, additionally comprising at least one polyethersulfone.

14. An epoxy resin composition according to claim 1, wherein [B] includes at least one aromatic polyamine.

15. An epoxy resin composition according to claim 1, wherein [B] includes at least one diaminodiphenylsulfone.

16. An epoxy resin composition according to claim 1, wherein [D] includes bis(3,4-epoxycyclohexyl).

17. An epoxy resin composition according to claim 1, wherein Y is a single bond, O, C(CH₃)₂, CH₂ or an oxirane ring.

18. An epoxy resin composition according to claim 1, wherein:
[A] includes at least one epoxy resin selected from the group consisting of triglycidyl ethers of tris(p-hydroxyphenyl)methane, N,N,N′,N′-tetraglycidyl-4,4′-diaminodiphenylmethane, triglycidyl-m-aminophenol, diglycidyl ethers of 1,6-dihydroxynaphthalene, and tetraglycidyl ethers of 1,6-bis(2-naphthyl)methane;
[B] includes at least one onium salt catalyst;
[C] includes at least one aromatic polyamine;
[D] includes at least one cycloaliphatic epoxy resin represented by formula (I), wherein Y is a single bond, O, C(CH₃)₂, CH₂ or an oxirane ring 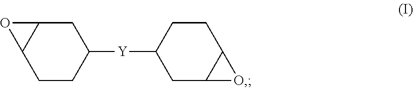
and the epoxy resin composition additionally comprises at least one thermoplastic resin.

19. An epoxy resin composition according to claim 1, wherein:
[A] includes at least one epoxy resin containing one or more naphthalene moieties;
[B] includes at least one diaminodiphenylsulfone;
[C] includes at least one onium salt catalyst represented by formula (II): 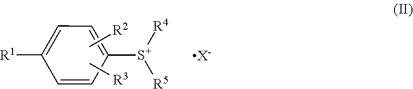
wherein R¹ represents a hydrogen atom, a hydroxyl group, an alkoxyl group, or a group represented by formula (III):
Y′—C(═O)—O— (III)
wherein Y′ represents an alkyl group, an alkoxyl group, a phenyl group or a phenoxy group, all of which may have one or more substituents, each of R² and R³ independently represents a hydrogen atom, a halogen atom, or an alkyl group, each of R⁴ and R⁵ independently represents an alkyl group, an aralkyl group or an aryl group, each of which may have one or more substituents, and X⁻ represents SbF₆⁻, PF₆⁻, AsF₆⁻, or BF₄⁻;
[D] includes at least one cycloaliphatic epoxy resin represented by formula (I), wherein Y is a single bond, O, C(CH₃)₂, CH₂ or an oxirane ring 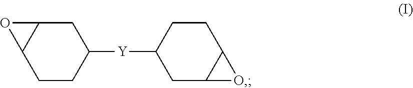
and the epoxy resin composition additionally comprises at least one polyethersulfone.

20. A prepreg comprising carbon fibers impregnated with an epoxy resin composition in accordance with claim 1.

21. A carbon fiber-reinforced composite material obtained by curing a prepreg in accordance with claim 20.

22. A carbon fiber-reinforced composite material comprising a cured resin product obtained by curing a mixture comprised of an epoxy resin composition in accordance with claim 1 and carbon fibers.

23. A carbon fiber-reinforced composite material according to claim 22 wherein the OHC strength tested at 180° C. H/W is greater than 125 MPa.
